(19) United States
(12) Patent Application Publication
(10) Pub. No.: US 2007/0261174 A1
(43) Pub. Date: Nov. 15, 2007

(54) Modular tools

(76) Inventor: Richard W. Barker, Gleadale, AZ (US)

Correspondence Address: SQUIRE SANDERS & DEMPSEY LLP, TWO RENAISSANCE SQUARE, 40 NORTH CENTRAL AVENUE, SUITE 2700, PHOENIX, AZ, 85004-4498, US

(21) Appl. No.: 11/796,093

(22) Filed: Apr. 25, 2007

Related U.S. Application Data
(60) Provisional application No. 60/745,596, filed on Apr. 25, 2006.

(51) Int. Cl. B26B 11/00

(52) U.S. Cl. 7/160; 7/158

(57) ABSTRACT

A device according to one embodiment of the present invention includes a plurality of tools. The device is preferably configured to be hand held and preferably has at least one tool at each end. The device includes a first module having a first tool and a second module having a second tool. The first module and second module are releasably coupled to form the device and may be coupled in any suitable manner. For example, each module may be coupled to a separate coupler, or a coupler may be formed in one or both of the modules to enable the two to be releasably attached.

### CROSS REFERENCE TO RELATED APPLICATIONS

This application claims priority from U.S. Provisional Application. No. 60/745,596 filed Apr. 25, 2006, in the name of Richard W. Barker and entitled “MODULAR WAREHOUSE TOOL SYSTEMS,” the portions of which that are not inconsistent with the description and scope of the invention as described and claimed herein are incorporated by reference.

### FIELD OF THE INVENTION

The present invention relates to modular tools. More particularly, the present invention relates to a modular device which includes a plurality of modules wherein each module includes at least one tool. The device may be structured and arranged to open boxes and mark boxes or perform other multiple functions.

### BACKGROUND OF THE INVENTION

Multiple tools are often needed for use in a variety of applications, which sometimes requires users to carry multiple, separate tools. In a warehouse environment, for example, there is a need for a device that is modular and includes multiple tools, such as one tool for marking and one tool for opening boxes. Further, there is a need for a device that enables a user to easily replace one or more modules of the device. Also, there is a need for a kit having a plurality of interchangeable modules, such as modules containing tools, that may be assembled to form a device having a plurality of tools. These and other issues are addressed by the present invention.

### SUMMARY OF THE INVENTION

A device according to one embodiment of the present invention is preferably sized to be held in the hand and includes two modules, wherein each module includes at least one tool. In one embodiment, one tool is a marker and the other tool is a cutter, such as a knife blade. The modules may be releasably attached to one or more other structures to form the device, or releasably attached together to form the device, utilizing any suitable structure to attach them. In a preferred embodiment the device comprises two modules attached to a coupler having a first end and a second end. A first module (including a first tool) attaches to the first end of the coupler and a second module (including a second tool, which is preferably a different tool than the first tool) attaches to the second end of the coupler to form a device according to the invention. The device thus has a first module at one end and a second module at the opposite end, and each of the modules includes at least one tool. If a separate coupling member is used it is preferred that the first module and second module are each releasably attached to the coupler. In some cases, however, (including one of the preferred embodiments described and claimed herein) such as when the tool in a module (or formed as part of a module) can be replaced without uncoupling the module, the module may be non-releasably attached to the coupler.

A replacement module according to another embodiment of the present invention has a first end, a tool and a second end, the second end being configured for releasably coupling to a coupler, wherein the coupler is configured to attach to the module.

### BRIEF DESCRIPTION OF THE DRAWINGS

FIG. 1 is a perspective view illustrating a modular tool according to the present invention.

FIG. 2 is a perspective view illustrating the modular tool in FIG. 1 in use.

FIG. 3 is an exploded perspective view, illustrating the assembly of the modular tool depicted in FIG. 1.

FIG. 4 is a sectional view of the modular tool depicted in FIG. 1.

FIG. 5 is a top view illustrating replacement modules according to the present invention.

### DETAILED DESCRIPTION OF THE EXEMPLARY EMBODIMENTS

A device according to the present invention may include any number of tools of any type and may be configured for any desired application. In one embodiment of the present invention, a device comprises: (1) a first module having a first end and a second end, and a second module having a first end and a second end, (2) a first tool retained in the first module and a second tool retained in the second module, and (3) a coupler having a first end and a second end, wherein the first end of the coupler connects (this may be either a releasable connection or non-releasable connection) to the second end of the first module, and the second end of the coupler connects to the second end of the second module.

A modular tool according to the present invention may be configured for any application, such as automotive, carpentry, electronics, or any other desired field and may be comprised of any combination of materials and be produced in any suitable manner. Any suitable type of tool may be used in conjunction with the present invention, such as a wrench, screwdriver, pliers, hammer, optical device (such as a magnifying glass), power tool (such as a drill or saw), air tool, electrical tool, a flashlight, laser pointer, or diagnostic equipment. A modular tool in accordance with the present invention may interface with any desired external system, such as a power source.

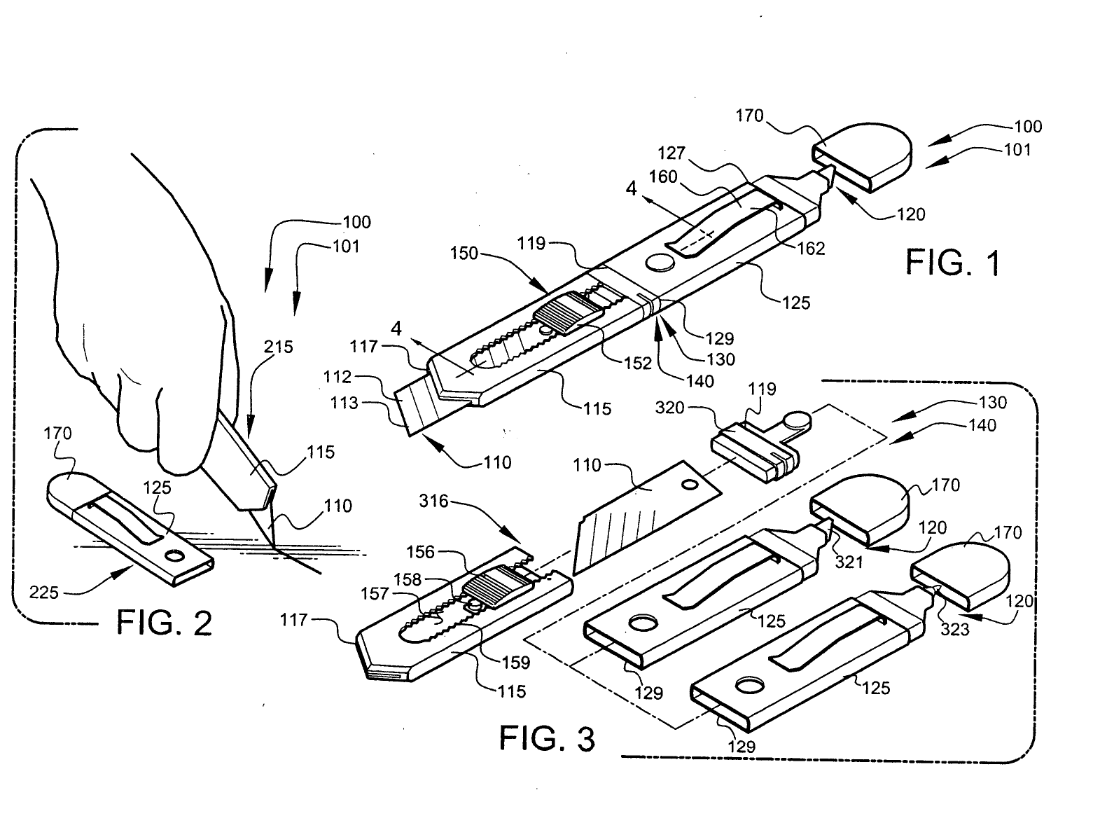

Referring now to the figures, where the purpose is to describe a preferred embodiment of the invention and not to limit same, FIG. 1, shows a device 100 that in the preferred embodiment comprises a device 101. In this exemplary embodiment, device 101 comprises a cutter 110; a marker 120; a first module 115 retaining the cutter 110, wherein first module 115 comprises at least one first end (or blade end) 117 and at least one second end (or connector end) 119. Device 101 also includes a second module 125 retaining a marker 120, wherein the second module 125 comprises at least a first end (or marker end) 127, and at least a second connector end 129; at least one coupler 130 structured and arranged to couple second end 119 to second end 129; and at least one releaser 140 structured and arranged to release coupler 130, from second module 125.

Device 101 may include, or operate in conjunction with, any number of desired tools, devices, and/or other warehouse tool components, such as safety features, a plurality of markers, storage of other markers, a plurality of cutters, storage of other cutters, lanyards, lights, bar code scanners, optical character readers, digital cameras, digital clocks, data storage devices, computer processors, laser pointers, and/or the like. Device 100 may include a flashlight retained in the first module 115 or second module 125, either as a tool or integrated with a module. The module may allow any portion of the flashlight to be replaced, such as the bulb and/or battery. The flashlight may have any suitable dimensions and may include a switch to activate and deactivate the flashlight, such as a push-button switch or slide switch.

Device 101 may further comprise at least one retractor 150 structured and arranged to retract cutter 110 relative to first module 115, as shown in FIG. 1. Retractor 150 comprises slider 156 (comprising connector 158) and groove 157. Cutter 110 connects to connector 158 and slider 156 slides along groove 157, causing cutter 110 to slide within first module 115. Retractor 150 slidingly extends and retracts cutter 110 in and out of blade end 117 of cutter handle 115 in response to pressure from the user.

Retractor 150 may comprise at least one selectable retractor 152 structured and arranged to selectably extend and retract cutter 110 relative to cutter handle 115, as shown in FIG. 1. Selectable retractor 152 incrementally slidingly extends and retracts cutter 110 in and out of blade end 117 of cutter handle 115 in response to pressure from the user. The groove 157 in selectable retractor 152 comprises ridged groove 159 to provide incremental locking positions for slider 156. The retractor 150 may include any other system or device for retracting the cutter 110. For example, the retractor 150 may include an automatic retractor. The retractor 150 may extend the cutter 110 to any suitable distance from the modular tool 101. In one exemplary embodiment of the present invention, the retractor can extend the cutter an inch or more from the cutter handle 115.

The cutter 110 may include any desired device or structure suitable for cutting, such as a knife blade. In the exemplary modular warehouse tool 101 depicted in FIG. 1, the cutter 110 comprises at least one razor blade 112, as shown. The razor blade 112 may include any type of blade, such as a utility blade manufactured by Martor USA, of Green Bay, Wis. The cutter 110 may comprise a razor blade 112 that includes one or more snap-off razor blades 113. The cutter 110 may include any type of snap-off razor blade 113, such as a snap-off utility blade manufactured by Martor USA, of Green Bay, Wis. The cutter 110 may include any number of other desired cutting devices, such as blunt tape slitters, laser cutters, hot cutters, vibrating cutters, knives of any sort, ultrasonic cutters, scissors, torches, and/or the like.

Device 101 may further comprise at least one connector 160 structured and arranged to connect device 101 to an object, such as a user's pocket. The connector 160 may include any suitable connector for attaching the tool to any number of desired objects. In the present exemplary embodiment, connector 160 comprises either at least one handle clip 162 structured and arranged to clip marker handle 125 to a user's pocket, or a magnet (not shown) attached to the device (such as to cap 170 or elsewhere) that then can be magnetically attached to another object. In one embodiment, the object is a lanyard, such as a cord or chain worn around a user's neck, and the magnet on the device attaches to a magnet on the lanyard. VELCRO may also be used to attach device 101 to an object.

As shown, connector 160 may comprise any structure and may be manufactured from any suitable material. In the present exemplary embodiment, connector 160 comprises at least one metal and/or plastic spring-clip. The connector 160 may connect to a pocket, clipboard, or any other desired object. The connector 160 may be any type of clip, such as a handle clip, magnetic clip, and/or the like. The connector 160 may include any other number of desired connectors of any configuration, such as magnets, lanyards, wrist straps, and/or the like. For example, the connector 160 may include a lanyard for securing the tool around the neck of a user. The connecter 160 may be attached to any module of device 101, such as to the second module 125 and/or the first module 115, the cap 170, or any other component of the modular tool. The connector 160 can be attached to the modular tool in any desired manner. The connector 160 may also be permanently connected to the modular tool. P Device 101 may comprise a cap 170 as shown in FIG. 1. The cap 170 fits over marker 120 to cover and protect marker 120 when marker 120 is not being used. The cap 170 may include any combination of suitable cap arrangements, such as screw-on caps, caps that post over the cutter end when the marker is in use, retractable markers, and/or the like. The cap 170 may include any other desired features. In one embodiment of the present invention, for example, the cap 170 comprises a magnet to magnetically attach to other objects. The magnet may be embedded in the cap 170 and may connect to any other suitable objects, such as a lanyard having a magnet to allow the modular tool to be worn around the neck of a user. The cap 170 (or the modular tool itself) can thus be releasably connected to the lanyard for carrying and easy access.

FIG. 2 shows a perspective view illustrating device 101 depicted in FIG. 1, in use. In this exemplary embodiment, first module 115 comprises at least one orienter 215 structured and arranged to orient cutter 110 in the user's hand, as shown. The orienter 215 enables the user to predict the orientation of cutter 110 by feeling the shape of cutter handle 115. The orienter 215 may be of any desired configuration, such as including at least one non-radially symmetrical shape of first module 115, as shown in FIG. 2. First module 115 may also comprise at least one rectangular cross-section, as shown in FIG. 2. First module 115 may include any other desired handle shape or combination of shapes, such as round handles, square handles, ergonomically shaped handles, one handle with a cutter and modularly replaceable markers on opposite ends, and/or the like. Any number of orienters may be employed in accordance with the present invention. For example, second module 125 depicted in FIG. 2 may include a second orienter 225 structured and arranged to orient marker 120 in the user's hand, as shown.

The individual tools of the modular tool 100 according to the present invention may be independently operable when disconnected from each other. For example, cutter 110 and marker 120 as depicted in FIG. 1 can each perform their separate function (cutting and marking, respectively) when disconnected from each other, although such independent functioning is not required. Device 101 comprising cutter 110 and marker 120 coupled together permits users to conveniently open and mark boxes without switching tools, resulting in time savings. P FIG. 3 shows an exploded perspective view, illustrating the assembly of the device 101 depicted in FIG. 1. First module 115 may comprise at least one cutter replacer 316 structured and arranged to assist replacement of cutter 110. In this exemplary embodiment, the cutter replacer 316 comprises a removable stopper 320 that friction-fits into first module 115. Removing removable stopper 320 provides access to cutter 110, so that cutter 110 can be removed and replaced from end 119. The replacer 316 may include any suitable structure, device, or system for replacing the cutter, such as side-opening cutter handles, automatic blade replacement devices, and/or the like.

The marker 120 comprises any suitable structure or device for marking, such as an ink marker, ball point pen, pencil or crayon. For example, as depicted in FIG. 3, the marker 120 may comprise a crayon 321 for writing on smooth surfaces such as plastic. Any suitable form of crayon 321 may be used in conjunction with the present invention, such as grease pencils, wax pencils, or china markers. The crayon 321 may be of any desired color. In an alternative exemplary embodiment, the marker 120 may comprise an ink pen 323, as shown in FIG. 3. Ink pens 323 are manufacturable in a plurality of colors and may include any form of pen, such as ball point pens, roller ball pens, gel pens, felt-tip pens, Sharpies, etc. Referring now to FIG. 5, in another alternative embodiment the marker 120 may comprise an ink marker 525. Ink markers 525 are manufacturable in a plurality of substantially opaque colors. Ink markers 525 can include a large fiber tip for writing. The marker 120 may also comprise a highlighter 527. Highlighter 527 are manufacturable in a plurality of substantially transparent colors and include a large fiber tip for writing. The marker 120 may include any other combination of marking tools, such as a pencil, stylus, mini-printer, paintbrush, watercolor sticks, engraver, tattoo needle, wood burner, and/or the like.

The coupler 130 connects modules of device 100 together. The coupler 130 may include any combination of structures and devices and may be formed as part of the first module or the second module, or both. A device 100 according to the present invention (including device 101) may include any number of couplers 130 to connect any desired number of tool-holding modules of device 100 together. For example, the coupler 130 depicted in FIG. 1 comprises releaser 140 and connects two modules of device 101 together. In this exemplary embodiment, the releaser 140 permits the user to disconnect first module 115 from second module 125 comprising a particular marker 120 (such as crayon 321). After first module 115 has been released from second module 125, first module 115 can be coupled to a different second module 125 comprising a different marker 120 (such as ink pen 323), as shown. First module 115 and second module 125 may also be uncoupled and then coupled to any other desired module having a tool, such as a cutter, maker, flashlight, screwdriver, etc., or may simply be uncoupled and replaced when the usable life of the respective tool has expired.

The modules can be coupled together in any suitable manner. As shown in FIG. 1, for example, first module 115 substantially rigidly and linearly couples with second module 125 via coupler 130. As shown, the second end 129 of second module 125 preferably is in contact with the second end 119 of first module 115. In this exemplary embodiment, the coupling is performed via linear motion, without torque, threaded connectors, or other twisting motion. However, device 100 may utilize any other suitable method for modularly coupling two or more tools together, such as snap fit, screw on or other.

The tools held by modules of device 100 can be independently replaced. For example, first module 115 (which in this embodiment holds cutter 110), and second module 125 (which in this embodiment holds marker 120) could each be replaced with other modules, respectively. Any other component of device 100 may similarly be replaced independent of the rest of the components. For example, the cap 170 is also an independently replaceable modular component.

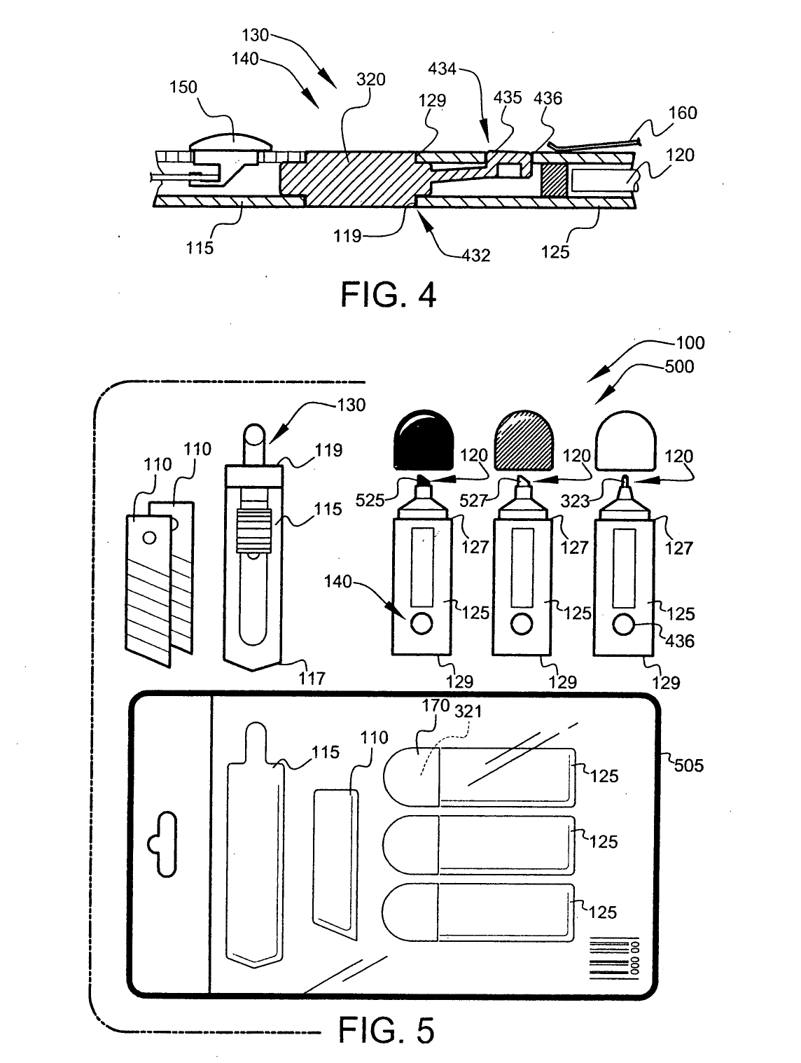

FIG. 4 shows sectional view of the modular tool depicted in FIG. 1. The coupler 130 comprises at least one friction-fit coupler 432, which comprises the friction fitting between second connector end 129 of marker handle 125 and first connector end 119 of cutter handle 115. The coupler 130 may include any device, system, and/or mechanism for coupling the modules of the modular tool together. As shown in FIG. 4, for example, the coupler 130 comprises at least one spring-tab-and-recess coupler 434, which in turn comprises at least one spring-tab 435 and at least one recess 436. The spring-tab 435 resiliently engages recess 436. First module 115 comprises spring-tab 435, while second module 125 comprises recess 436. In operation, the first module 115 and second module 125 are pressed together whereby spring-tab 435 aligns with and engages recess 436. The coupler 130 comprises releaser 140. The releaser 140 may include any device, system, and/or mechanism for releasing the coupling holding the modules of the modular tool together. In the exemplary embodiment depicted in FIG. 4, first module 115 and second module 125 are separated by pressing spring-tab 435 to disengage spring-tab 435 from recess 436 and then pulling first module 115 and second module 125 apart. The coupler 130 may include any other desired systems, devices, and methods for coupling, such as friction coupling, snap coupling, magnetic coupling, temporary adhesive coupling, connections requiring rotation less than one hundred eighty degrees, the spring-tab-and-recess coupler structured and arranged to function in multiple marker handle orientations, etc.

FIG. 5 shows a top view illustrating replacement tools according to various aspects of the present invention. In this exemplary embodiment, kit 500 comprises at least one device 101 comprising at least one first module 110; at least one first marker 120; at least one cutter handle 115 structured and arranged to retain the first cutter 110; wherein the first module 115 comprises at least a first end (or blade end) 117 and at least a second end 119; at least one second module 125 structured and arranged to retain the first marker 120; wherein first module 125 comprises at least a first end (or marker end) 127 and at least one second end 129; at least one coupler 130 structured and arranged to couple to second end 119 and to second end 129; at least one releaser 140 structured and arranged to release coupler 130; at least one second marker 120; wherein first marker 120 and second marker 120 are interchangeable; and at least one consumer packaging 505 structured and arranged to package modular warehouse tool 101 and second marker 120, as shown. As previously described, however, the kit could contain any suitable types of tools, and any suitable coupler could be used. P In this exemplary replacement kit, the first marker 120 and second marker 120 can be any suitable marker 120, such as an ink marker 525, a highlighter 527, a crayon 321, or an ink pen 323. The user of the kit 500 may select the first marker 120 and second marker 120 according to preference. The kit 500 further comprises at least one second cutter 110 wherein first cutter 110 and second cutter 110 are interchangeable, as shown. A user can replace the first cutter 110 with second cutter 110 when first cutter 110 becomes dull, damaged, etc. The replacement kit 500 may include any other suitable components, such as instructions, multiple colors of the same type of marker, multiple colors of handles, alternate modular tools, other replacement components (such as marker caps, lanyards, and the like) or any other desired component.

The foregoing description discusses exemplary embodiments of the present invention which may be changed or modified without departing from the scope of the present invention as defined in the claims. While for the sake of clarity of description, several specific embodiments of the invention have been described, the scope of the invention is intended to be measured by the following claims and legal equivalents thereof.

What is claimed is:

1. A device including a plurality of tools, the device comprising:
a first module having a first end and a second end,
a second module having a first end and a second end;
a first tool retained in the first module;
a second tool retained in the second module; and
a coupler having a first end and a second end, the first end of the coupler for connecting to the second end of the first module and the second end of the coupler for releasably connecting to the second end of the second module.

2. The device according to claim 1 that includes a release device for releasing the second module.

3. The device according to claim 1 wherein the first end of the coupler is releasably connected to the second end of the first module and wherein the device includes one or more release devices for releasing the first module and the second module.

4. The device of claim 1 wherein the second end of the first module is in contact with the second end of the second module when the first module and second module are both attached to the coupler.

5. The device of claim 1 wherein the coupler is a separate component that is not formed as part of the first module or the second module.

6. The device of claim 1 wherein the coupler is formed as part of either the first module or the second module.

7. The device of claim 1 wherein the first tool comprises a cutter and the second tool comprises a marker.

8. The device of claim 7 further comprising a retractor for slidably extending and retracting the cutter from the first module.

9. The device of claim 7 wherein the cutter comprises a knife blade.

10. The device of claim 9 wherein the knife blade comprises a snap-off razor blade.

11. The device of claim 7 further comprising a cap for protecting the marker.

12. The device of claim 1 wherein the device includes a magnet to magnetically attach to another object for carrying.

13. The device of claim 12 wherein the magnet is connected to the cap.

14. The device of claim 7 wherein the cutter can be extended ½″ or more outside of the first module.

15. The device of claim 7 wherein the cutter can be extended 1″ or more outside of the first module.

16. The device of claim 1 wherein the first tool is one of a flashlight, screwdriver, cutter, marker or wrench.

17. The device of claim 1 further including a flashlight attached to the device.

18. The device of claim 17 wherein the flashlight is not the first tool or the second tool.

19. The device of claim 1 further including a lanyard that is releasably attached to the device, the lanyard for being attached to the body of a user.

20. The device of claim 19 wherein the lanyard is configured to be worn around the neck of a user.

21. The device of claim 19 wherein the lanyard includes a magnet, the device includes a magnet, and the lanyard is releasably attached to the device by the attraction of the two magnets.

22. The device of claim 19 wherein the lanyard includes VELCRO, the device includes VELCRO, and the lanyard is releasably attached to the device by attaching the VELCRO on the device to the VELCRO on the lanyard.

23. The device of claim 1 wherein the first tool or the second tool is a pencil.

24. The device of claim 1 further comprising a connector for attaching the device to an object.

25. The device of claim 24 wherein the connector comprises a handle clip.

26. The device of claim 1 wherein the coupler comprises at least one of a friction-fit coupler and a spring-tab-and-recess coupler.

27. The device of claim 1 wherein the device comprises at least one non-radially symmetrical shape for orienting the device in a user's hand.

28. The device of claim 1 wherein the length of the device is between 6 and 10 inches.

29. The device of claim 1 wherein the width of the device is between 1 and 2½ inches.

30. The device of claim 1 wherein the length of the device is about 8 inches.

31. The device of claim 1 wherein the width of the device is about 1½ inches.

32. A replacement module comprising:
a module comprising a tool, a first end and a second end, the second end being configured for releasably coupling to a coupler, wherein the coupler is either formed as part of a second module comprising a second tool or is configured to releasably attach to the second module, the coupler having a second end configured for releasably coupling to the first module.

33. The replacement tool of claim 31 wherein the first tool comprises a cutter.

34. The replacement tool of claim 31 wherein the first tool comprises a marker.
